(19) United States
(12) Patent Application Publication
(10) Pub. No.: US 2023/0275460 A1
(43) Pub. Date: Aug. 31, 2023

(54) FERRITE STRUCTURE FOR IMPROVED MAGNETIC COUPLING

(71) Applicant: Apple Inc., Cupertino, CA (US)

(72) Inventors: Zelin Xu, San Jose, CA (US); Brennan K Vanden Hoek, Bear Valley, CA (US); Antoin J Russell, Mountain View, CA (US); Daniel J Hiemstra, San Francisco, CA (US); Eric X Zhou, San Jose, CA (US); Tao Pan, San Jose, CA (US)

(21) Appl. No.: 17/804,922

(22) Filed: Jun. 1, 2022

Related U.S. Application Data
(60) Provisional application No. 63/268,662, filed on Feb. 28, 2022.

(51) Int. Cl. H02J 50/00; H02J 50/10; H01F 38/14; H01F 27/255

(52) U.S. Cl. CPC H02J 50/005; H02J 50/10; H01F 38/14; H01F 27/255

(57) ABSTRACT

An electronic device can include a metallic or non-metallic housing having a window therethrough, a wireless power transfer coil disposed inside the housing adjacent the window, and a non-metallic cover disposed within the window that protects the wireless power transfer coil, the non-metallic cover incorporating at least one ferromagnetic region that improves magnetic coupling of the wireless power transfer coil to a corresponding wireless power transfer coil of another device by providing a high magnetic permeability flux path. The non-metallic cover and the at least one ferromagnetic region have surface finishes selected to visually match or coordinate with the housing.

### CROSS-REFERENCE TO RELATED APPLICATIONS

This application claims priority to and benefit of U.S. Provisional Application No. 63/268,662, filed Feb. 28, 2022, and entitled “FERRITE STRUCTURE FOR IMPROVED MAGNETIC COUPLING,” which is incorporated herein by reference in its entirety for all purposes.

### BACKGROUND

Some electronic devices include wireless power transfer circuitry to facilitate operations such as charging a battery of the electronic device or charging a battery of an accessory to the device. For suitable operation of a wireless power transfer system, such as an inductive wireless power transfer system, the magnetic field associated with the wireless power transfer magnetically couples a wireless power transfer coil in the electronic device to its counterpart, whether that counterpart be a power transmitter, power receiver, or both. One way to allow for such magnetic coupling is to use a non-metallic housing for the electronic device—at least in the vicinity and flux path of the wireless power transfer system. Such housings have been made from plastic, glass, and other non-metallic substances. However, some electronic devices use metallic housings, which may impede wireless power transfer unless they incorporate a window to allow for magnetic coupling of the internal wireless power transfer components with the external wireless power transfer system. Such windows may also be used with non-metallic housing and may be formed from a hole in the housing that can be filled with a non-metallic cover to provide mechanical and moisture protection to the wireless power transfer coil (and other components) while allowing magnetic flux to pass. However, the thickness of these non-metallic covers can result in a reduction in the degree of coupling between the internal wireless power transfer coil and the external device.

### SUMMARY

An electronic device configured for wireless power transfer can include a housing with a window therein to allow for enhanced coupling between an internal wireless power transfer coil and a corresponding wireless power transfer coil of a counterpart device. The window can be filled with a non-metallic cover to provide mechanical and moisture protection to the internal components, including the wireless power transfer coil. The cover can also include material in the form of a non-metallic substance doped with ferromagnetic particles to provide for enhanced coupling between the internal wireless power transfer coil and the external counterpart coil. Such a structure permits passage of wireless flux while maintaining necessary protection to the device's internal components.

An electronic device can include a housing having a window therethrough, a wireless power transfer coil disposed inside the housing adjacent the window, and a non-metallic cover disposed within the window that protects the wireless power transfer coil, the non-metallic cover incorporating at least one ferromagnetic region that improves magnetic coupling of the wireless power transfer coil to a corresponding wireless power transfer coil of another device by providing a high magnetic permeability flux path. The non-metallic cover and the at least one ferromagnetic region have surface finishes selected to visually match or coordinate with the housing. The housing can be metallic or non-metallic.

The non-metallic cover can be formed from a polymer material. The non-metallic cover can be plastic or rubber. The at least one ferromagnetic region can have one or more dimensions selected to match a corresponding dimension of a core of the wireless power transfer coil. The at least one ferromagnetic region can have a thickness selected to reduce or eliminate an air gap between the core of the wireless power transfer coil and a core of the corresponding wireless power transfer coil of another device. The ferromagnetic region can be formed from a non-metallic matrix or substrate material with ferromagnetic particles disposed therein. The non-metallic matrix or substrate material can be the same material as the non-metallic cover. The ferromagnetic particles can be powdered, causing the ferromagnetic region to have an isotropic magnetic flux characteristic. The ferromagnetic particles can be flakes and can be oriented within the ferromagnetic region to cause the ferromagnetic region to have an anisotropic magnetic flux characteristic.

A method of forming a cover for a window through a housing of an electronic device (wherein the cover incorporates a ferromagnetic region that improves magnetic coupling of a wireless power transfer coil in the electronic device to a corresponding wireless power transfer coil of another device by providing a high magnetic permeability flux path) can include disposing material including a non-metallic matrix or substrate having ferromagnetic particles dispersed therein into a reservoir of a non-metallic blank and co-finishing the resulting structure to provide desired dimensions and surface finish of the cover and ferromagnetic region. The method can further include curing the material disposed in the reservoir of the non-metallic blank prior to co-finishing the resulting structure. The non-metallic blank can be a molded polymer part. The co-finishing step can be a machining operation. The co-finishing step can be applied to more than one face of the resulting structure.

An electronic device can include a metallic or non-metallic housing having a window therethrough, a wireless power transfer coil disposed inside the housing adjacent the window, and a non-metallic cover disposed within the window that protects the wireless power transfer coil. The non-metallic cover can incorporate at least one ferromagnetic region that improves magnetic coupling of the wireless power transfer coil to a corresponding wireless power transfer coil of another device by providing a high magnetic permeability flux path. At least one of the non-metallic cover and ferromagnetic region can be coated to provide a surface finish selected to visually match or coordinate with the housing. Both the non-metallic cover and the ferromagnetic region can be coated to provide a surface finish selected to visually match or coordinate with the housing. The coating material can be the same material as the non-metallic cover. The ferromagnetic region can be formed from a non-metallic matrix or substrate material with ferromagnetic particles disposed therein. The ferromagnetic particles can be flakes oriented within the ferromagnetic region to cause the ferromagnetic region to have an anisotropic magnetic flux characteristic.

### BRIEF DESCRIPTION OF THE DRAWINGS

FIGS. 1A and 1B depict respective views of a portion of an electronic device with a housing, a window therethrough for wireless power transfer, and a non-metallic cover.

FIGS. 2A and 2B depict respective views of a portion of an electronic device with a housing, a window therethrough for wireless power transfer, and a non-metallic cover incorporating ferromagnetic regions for improved magnetic coupling.

FIG. 3 depicts an exemplary process for forming a non-metallic cover incorporating a ferromagnetic region.

FIG. 4 depicts an alternative exemplary process for forming a non-metallic cover incorporating a ferromagnetic region.

FIGS. 5A and 5B depict orthogonal views of a ferromagnetic region incorporating a flaked ferromagnetic material to provide different magnetic permeability in different directions or orientations.

FIG. 6 depicts an electronic device with a housing, a window therethrough for wireless power transfer, and a non-metallic cover incorporating ferromagnetic regions in the form of a ferrite with a cosmetic coating.

FIG. 7 depicts an electronic device with a housing, a window therethrough for wireless power transfer, and a non-metallic cover incorporating ferromagnetic regions in the form of a ferrite with a cosmetic coating in which the coating covers both the ferrite and the surrounding non-metallic cover.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth in order to provide a thorough understanding of the implementations described herein. In other instances, methods, procedures and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a drawing, refers to the same element throughout the several drawings, though it may not be repeated in every drawing. The drawings are not to scale unless otherwise indicated, and the proportions of certain parts may be exaggerated to better illustrate details and features of the present disclosure.

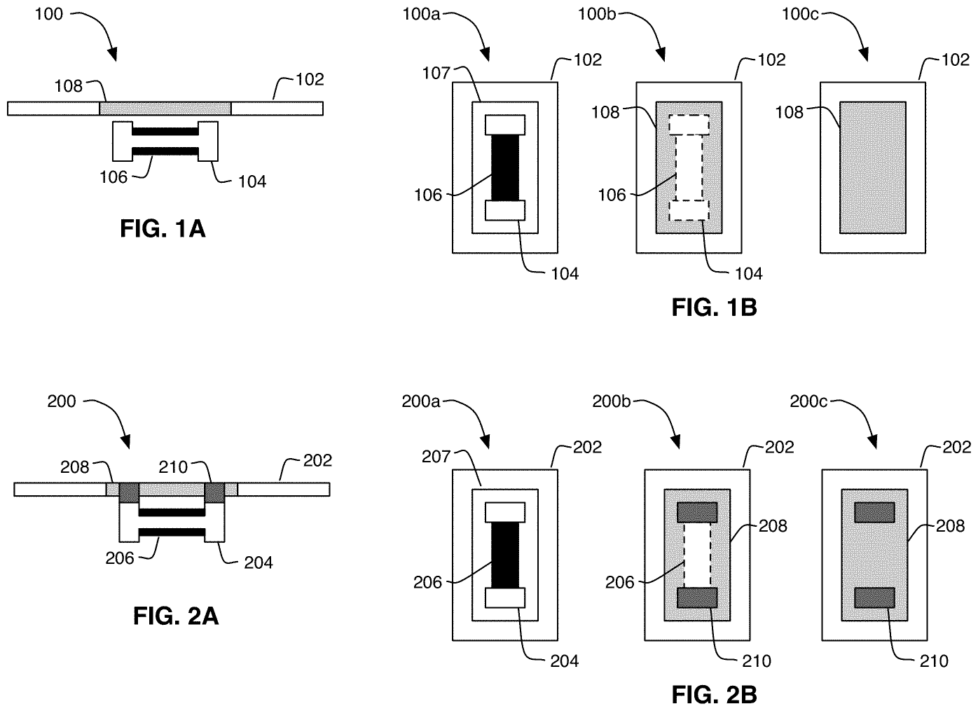

FIGS. 1A and 1B depict respective views of a portion of an electronic device 100 with a housing 102, a window therethrough for wireless power transfer (e.g., inductive power transfer), and a non-metallic cover 108. The housing may be metallic or non-metallic. More specifically, FIG. 1A depicts a cross sectional view showing housing 102, which has a window or opening therethrough that is located “above” the wireless power transfer coil, which can include winding 106 wrapped around a core 104. Although illustrated and described herein as “above,” it is to be understood that the window through the housing and wireless power transfer coil could be disposed in any orientation in any surface of the electronic device, such that it could be above, below, beside, etc. Also, the illustrated orientation and configuration of the wireless power transfer coil, with a “dumbbell-shaped” core 104 and a winding wound around a central longitudinal portion of such core is but one example configuration. Numerous other coil configurations could be provided. In the illustrated example, core 104 can be formed from a ferrite material, e.g., a ceramic or other non-metallic/non-conductive material with ferromagnetic particles disposed therein. Alternatively, in some embodiments, a metallic core made from magnet steel sheets like those used for transformer or motor cores could be used. Likewise, the wireless power transfer coil could be positioned in any desired orientation with respect to electronic device 100 and the window through housing 100. The illustrated horizontal configuration is but one exemplary configuration.

Electronic device 100 can include a non-metallic cover 108 that can be disposed within the window through housing 102. Non-metallic cover 108 can be formed from any suitable material. Suitability can include: (1) being non-conductive so as to allow for magnetic coupling between the wireless power transfer winding and a corresponding external wireless power transfer winding, (2) having mechanical properties that provide a suitable degree of mechanical protection (including moisture ingress protection) for the wireless power transfer winding and other internal components of electronic device 100, (3) a surface finish that provides an aesthetically-pleasing look to electronic device by matching or otherwise coordinating with housing 102, and (4) any other desired properties. Exemplary materials that may be used include polymer materials such as plastic, rubber, etc.

Non-metallic cover 108 can be secured in the window through housing 102 in a variety of ways, including an interference fit (in which friction between the mating surfaces of housing 102 and non-metallic cover 108 retain the non-metallic cover in position), adhesives (in which housing 102 is bonded to non-metallic cover 108), or mechanical retaining features (such as flanges or other fixtures that serve to retain non-metallic cover 108). In some embodiments, other securing techniques or combinations of the listed securing techniques could be used as appropriate. Also, as illustrated in FIG. 1A, there may be a slight gap between the wireless power transfer coil and the non-metallic cover 108. Alternatively, this gap could be eliminated and used as part of the mechanism for securing non-metallic cover 108, potentially in common with one or more of the above-described securing techniques. For example, a flange on the internal side of non-metallic cover 108 could prevent it from falling out of the window, while the wireless power transfer winding could be secured inside the housing of the electronic device by any appropriate technique, and the immobility of the wireless power transfer winding could prevent non-metallic cover 108 from falling out of the window into the inside of the housing.

FIG. 1B illustrates a series of plan views 100a-100c of the arrangement described above with reference to FIG. 1A. More specifically, plan view 100a shows housing 102 with a window 107 therein. Non-metallic cover 108 is omitted from this view so that the wireless power transfer coil, including dumbbell shaped core 104 and winding 106 can be seen. View 100b adds non-metallic cover 108, with the wireless power transfer winding shown in dashed lines “beneath” the cover. (As noted above, the illustrated orientation is exemplary, and the components could be above/below/beside depending on the particular application.) Finally, view 100c shows non-metallic cover 108 disposed within window 107 through housing 102 as it would appear in an actual view. As illustrated, it may be possible to perceive the difference between non-metallic cover 108 and surrounding housing material 102, but this difference may be minimized or otherwise coordinated to provide an aesthetically pleasing result.

FIGS. 2A and 2B depict respective views of a portion of an electronic device 200 with a housing 202, a window therethrough for wireless power transfer, and a non-metallic cover 208 incorporating ferromagnetic regions 210 for improved magnetic coupling. Housing 202 may be metallic or non-metallic. More specifically, FIG. 2A depicts a cross sectional view showing housing 202, which has a window or opening therethrough that is located “above” the wireless power transfer coil, which can include winding 206 wrapped around a core 204. Although illustrated and described herein as “above,” it is to be understood that the window through the housing and wireless power transfer coil could be disposed in any orientation in any surface of the electronic device, such that it could be above, below, beside, etc. Also, the illustrated orientation and configuration of the wireless power transfer coil, with a “dumbbell-shaped” core 204 and a winding wound around a central longitudinal portion of such core is but one example configuration. Numerous other coil configurations could be provided. In the illustrated example, core 204 can be formed from a ferrite material, e.g., a ceramic or other non-metallic/non-conductive material with ferromagnetic particles disposed therein. Alternatively, in some embodiments, a metallic core made from magnet steel sheets like those used for transformer or motor cores could be used. Likewise, the wireless power transfer coil could be positioned in any desired orientation with respect to electronic device 200 and the window through housing 202. The illustrated horizontal configuration is but one exemplary configuration.

Electronic device 200 can include a non-metallic cover 208 that can be disposed within the window through housing 202. Non-metallic cover 208 can be formed from any suitable material. Suitability can include: (1) being non-conductive so as to allow for magnetic coupling between the wireless power transfer winding and a corresponding external wireless power transfer winding, (2) having mechanical properties that provide a suitable degree of mechanical protection (including moisture ingress protection) for the wireless power transfer winding and other internal components of electronic device 200, (3) a surface finish that provides an aesthetically-pleasing look to electronic device by matching or otherwise coordinating with housing 202, and (4) any other desired properties. Exemplary materials that may be used include polymer materials such as plastic, rubber, etc.

Non-metallic cover 208 can also incorporate or otherwise provide for one or more ferromagnetic regions 210. Ferromagnetic regions 210 can improve the degree of magnetic coupling between the wireless power transfer coil and a complementary wireless power transfer coil in an external device. Ferromagnetic regions 210 can achieve this by serving as a relatively higher magnetic permeability path for flux lines induced by winding 206 in core 204 into a corresponding power transfer winding of an external device. Such an arrangement can also reduce the effective distance between the respective wireless power transfer coils, which can also improve magnetic coupling. To that end, ferromagnetic regions 210 may be dimensioned and positioned relative to core 204 so as to provide the desired flux path. As a result, the dimensions of ferromagnetic regions 210 may correspond to certain features of core 204 (e.g., the dumbbell ends) and may have a height that can serve to reduce or eliminate the airgap between core 204 and a corresponding core of a counterpart wireless power transfer coil in an external device. Exemplary ferromagnetic region materials and construction techniques are described in greater detail below, but in general may include a suitable non-metallic matrix or substrate material with a distribution of ferromagnetic particles disposed therein. Optionally, the externally facing and internally facing surfaces of ferromagnetic regions 210 may have different dimensions, such as its externally facing (i.e., exposed) dimension and position are aligned with the wireless power transfer structure of a complementary external device, such as the wireless transfer coil and ferrite core of a wireless power receiver or transmitter, so as to provide an improved flux path between the respectively wireless power transfer stacks of mated devices.

Non-metallic cover 208 can be secured in the window through housing 202 in a variety of ways, including an interference fit (in which friction between the mating surfaces of housing 202 and non-metallic cover 208 retain the non-metallic cover in position), adhesives (in which housing 202 is bonded to non-metallic cover 208), or mechanical retaining features (such as flanges or other fixtures that serve to retain non-metallic cover 208). In some embodiments, other securing techniques or combinations of the listed securing techniques could be used as appropriate. Likewise, ferromagnetic regions 210 may be retained in non-metallic cover 208 in corresponding fashion. Also, as illustrated in FIG. 1A, there may be a slight gap between the wireless power transfer coil and the non-metallic cover 208, although this gap may be at least partially filled by the ferromagnetic regions in at least some places to provide the enhanced magnetic coupling intended. Alternatively, and as described above, this gap could be eliminated and used as part of the mechanism for securing non-metallic cover 208 and/or ferromagnetic regions 210, potentially in common with one or more of the above described securing techniques. For example, a flange on the internal side of non-metallic cover 208 and/or ferromagnetic regions 210 could prevent them from falling out of the window, while the wireless power transfer winding could be secured inside the housing of the electronic device by any appropriate technique, and the immobility of the wireless power transfer winding could prevent non-metallic cover 208 and/or ferromagnetic regions 210 from falling out of the window into the inside of the housing.

FIG. 2B illustrates a series of plan views 200a-200c of the arrangement described above with reference to FIG. 2A. More specifically, plan view 200a shows housing 202 with a window 207 therein. Non-metallic cover 208 and ferromagnetic regions 210 are omitted from this view so that the wireless power transfer coil, including dumbbell shaped core 204 and winding 206 can be seen. View 200b adds non-metallic cover 208 and ferromagnetic regions 210, with the wireless power transfer winding shown in dashed lines “beneath” the cover, but with ferromagnetic regions 210 shown above the ends of core 204. (As noted above, the illustrated orientation is exemplary, and the components could be above/below/beside depending on the particular application.) Finally, view 200c shows non-metallic cover 208 with ferromagnetic regions 210 disposed within window 207 through housing 202 as it would appear in an actual view. As illustrated, it may be possible to perceive the difference between non-metallic cover 208, ferromagnetic regions 210, and/or surrounding housing material 202, but this difference may be minimized or otherwise coordinated to provide an aesthetically pleasing result. In other words, ferromagnetic regions 210 and the abutting portions of non-metallic cover 208 are visually matched to provide enhanced cosmetic properties.

As noted above, the ferromagnetic regions 210 can be formed from a non-metallic matrix or substrate material doped with ferromagnetic particles. The non-metallic matrix or substrate material could be the same material as used for non-metallic cover 208, or could be a similar material, or could be an entirely different material. Examples of such matrix or substrate materials include polymers, plastics, epoxies, etc. The ferromagnetic dopant could be any of a variety of ferromagnetic particles including a powdered or flaked ferromagnetic materials. As described in greater detail below with reference to FIGS. 5A and 5B, a powdered material may be used to provide a ferromagnetic region having isotropic magnetic flux characteristics, such as uniform magnetic permeability in all directions. Such a powdered material may have particles shapes that are substantially similar in all three spatial dimensions. Conversely, a flaked material can have particles that have a greater extent in a two-dimensional plane than in an orthogonal axis. Such flaked ferromagnetic materials may be used to produce a ferromagnetic region having anisotropic magnetic flux characteristics, such as a different magnetic permeability in one direction versus a different magnetic permeability in an orthogonal direction.

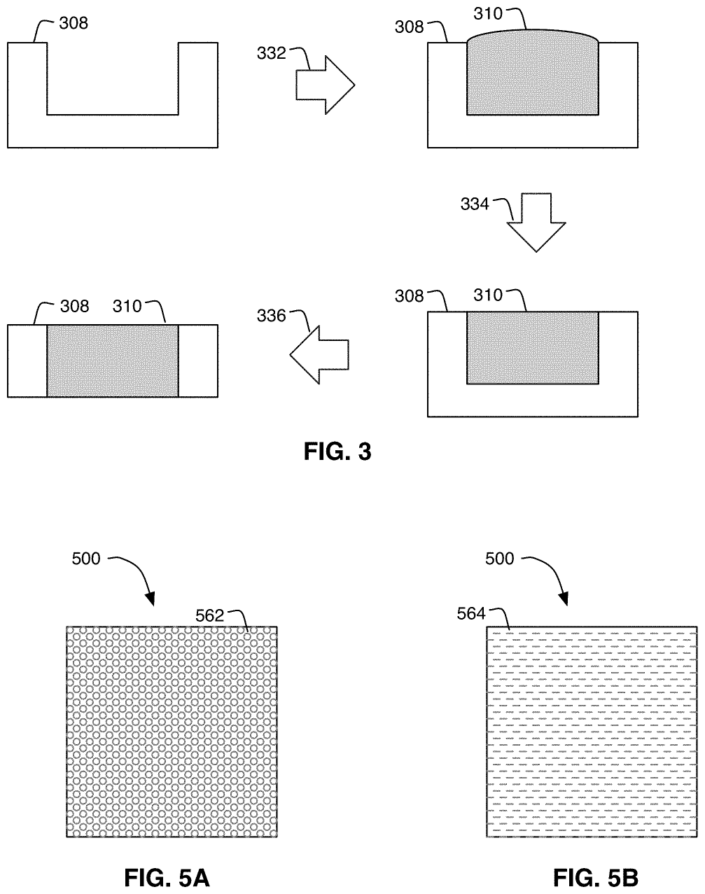

FIG. 3 depicts an exemplary process for forming a non-metallic cover incorporating a ferromagnetic region. The process can begin with a non-metallic blank 308 having a predetermined shape. The shapes depicted in FIG. 3 are greatly simplified and are intended to provide an understanding of the basic process. Any shape could be used as appropriate for a given application. The shape may in general correspond in dimension to the size of the window in the metallic electronic device housing that it is to fill, with allowances for further processing steps. The non-metallic blank 308 can also include a reservoir for containing the ferromagnetic region, which can be produced as described in greater detail below. The non-metallic blank 308 can be formed from any suitable non-metallic material by any suitable process for such material. As one example, non-metallic blank 308 could be an injection molded polymer. In other cases, non-metallic blank 308 could be formed by another molding process applied to a suitable plastic or rubber material. In some cases, non-metallic blank 308 could be formed by a machining process. In any case, as indicated by process arrow 332, a ferromagnetic region may be formed by disposing a suitable material including a matrix or substrate material with magnetic particles dispersed therein within the reservoir of the non-metallic blank 308 to form ferromagnetic region 310. Such disposition could include a pouring/molding or other injection type process. The ferromagnetic region may, if necessary, be allowed to cure so as to solidify into its final form. Such curing process may be determined by selection of the matrix or substrate material.

In some cases, the above-described process may result in a ferromagnetic region 310 with a shape that extends beyond what is desired for the finished product. If so, a co-finishing step, indicated by process arrow 334, may be applied to conform ferromagnetic region 310 (and optionally non-metallic blank 308) to a dimension and/or surface finish suitable for use in the finished electronic device product. As one example, the top surface of the combined structure of non-metallic blank 308 and ferromagnetic region 310 may be machined to provide the desired thickness and surface finish. Optionally and additionally, process step 336 can include further processing of one or more other sides of the combined structure to provide the desired dimensions and/or surface finishes.

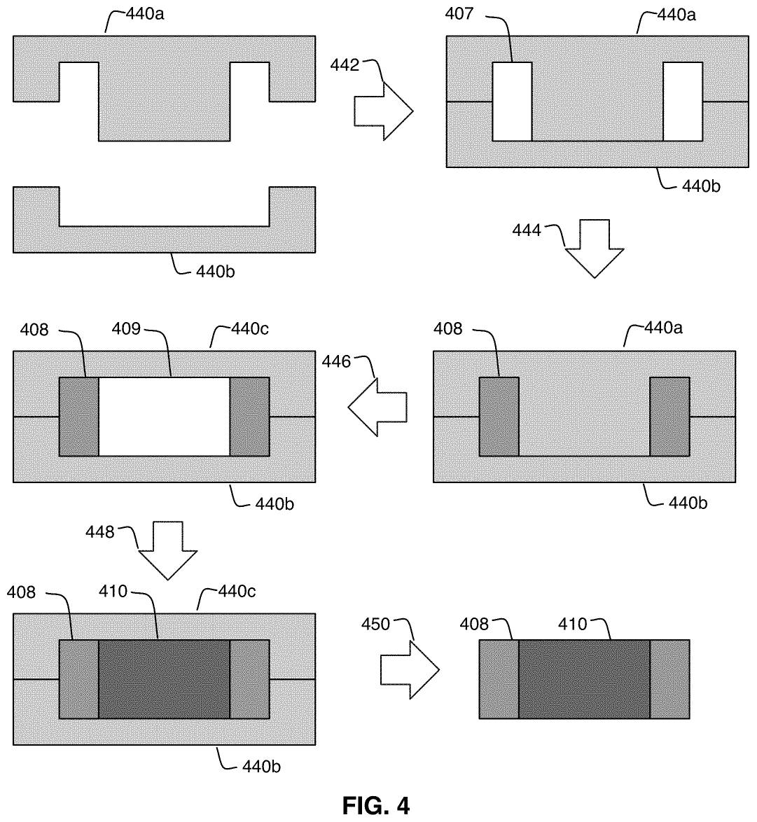

FIG. 4 depicts an alternative exemplary process for forming a non-metallic cover incorporating a ferromagnetic region. This alternative exemplary process is a multi-shot injection molding process that begins with a mold. The mold can be a multi-piece mold, for example, a top mold piece 440a and a bottom mold piece 440b. The respective mold pieces may be shaped so as to provide reservoirs for injected material that will form the desired shape of the final non-metallic cover 408 and ferromagnetic region 410 as described in greater detail below. The shapes depicted in FIG. 4 are greatly simplified and are intended to provide an understanding of the basic process. Any shape could be used as appropriate for a given application.

In process step 442, the mold can be closed to form void 407 corresponding to non-metallic cover 408. In process step 444, a suitable material for non-metallic cover 408 can be injected into mold void 407 and subsequently allowed to cure. Depending on the particular material used, the curing process can include controlled heat/temperature, passage of time, etc. Once non-metallic cover portion 408 has cured (if necessary) the system can be set up for the second shot of the molding process. In some cases, this may include adding or replacing a mold portion, such as replacing a mold top piece 440a with an alternative mold top piece 440c that defines a void 409 for the ferromagnetic region material. Then, in process step 448, a suitable material for forming ferromagnetic region 410 (as described above) may be injected into void area 409. Depending on the particular materials used, a further curing step may be applied. Such curing step could again include controlled heat/temperature and/or passage of time or any other process appropriate to the materials used. Then, in process step 450, the finished product including non-metallic cover 408 with integrated ferromagnetic region 410 can be removed from the mold. Such a process may be used to form a suitable non-metallic cover 408 and ferromagnetic region 410 structure that requires no or minimal post-processing to achieve the desired dimensions and surface finishes.

FIGS. 5A and 5B depict orthogonal views of a ferromagnetic region incorporating a flaked ferromagnetic material to provide different magnetic permeability in different directions or orientations. As briefly noted above, a powdered ferromagnetic material may be introduced into the matrix/substrate material to produce a ferromagnetic region having isotropic magnetic flux characteristics, such as uniform magnetic permeability in all directions, while a flaked ferromagnetic material can be used to produce a ferromagnetic region having anisotropic magnetic flux characteristics, such as a different magnetic permeability in one direction as opposed to a different magnetic permeability in an orthogonal direction. A simplified depiction of such an anisotropic ferromagnetic region 500 is illustrated in FIGS. 5A and 5B. FIG. 5A illustrates such material when looking on a first direction that is orthogonal to a second direction, illustrated in FIG. 5B. In FIG. 5A, the view is perpendicular to a face of the ferromagnetic flakes 562. In FIG. 5B, the view is parallel to a plane of the ferromagnetic flakes 564. Disposing the ferromagnetic materials in such a way may require that the ferromagnetic region amalgam be formed and/or cured using a process that provides suitable orientation of the flaked ferromagnetic material. For example, in either of the cosmetic formation processes described above with reference to FIGS. 3 and 4, the liquid material with the ferromagnetic flakes may be subject to electric or magnetic fields and/or electric currents that produce the desired orientations. Then, once the ferromagnetic region has cured, the flaked ferromagnetic material will be “locked” into the desired orientation, resulting in the desired anisotropy.

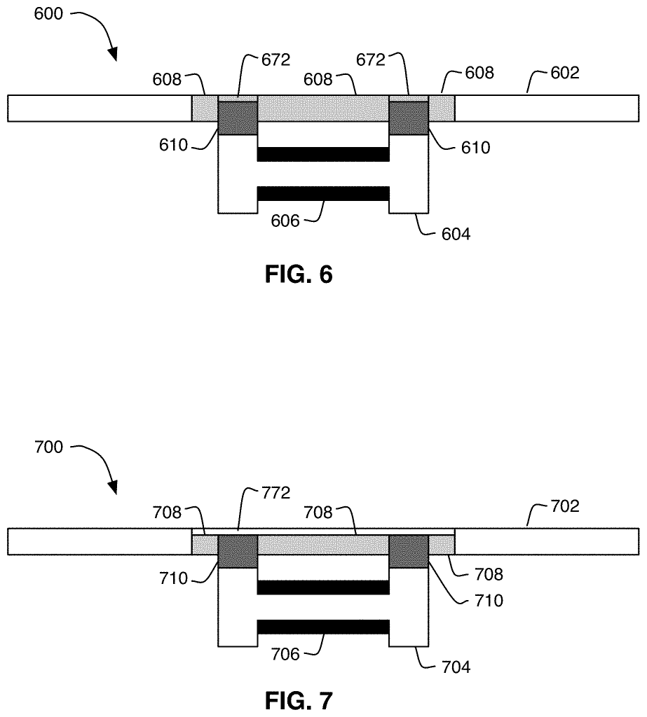

FIG. 6 depicts an electronic device 600 with a housing 602, a window therethrough for wireless power transfer, and a non-metallic cover 608 incorporating ferromagnetic regions in the form of a ferrite 610 with a cosmetic coating 672. Housing 602 may be metallic or non-metallic. More specifically, FIG. 6 depicts a cross sectional view showing housing 602, which has a window or opening therethrough that is located “above” the wireless power transfer coil, which can include winding 606 wrapped around a magnetic core 604. Although illustrated and described herein as “above,” it is to be understood that the window through the housing and wireless power transfer coil could be disposed in any orientation in any surface of the electronic device, such that it could be above, below, beside, etc. Also, the illustrated orientation and configuration of the wireless power transfer coil, with a “dumbbell-shaped” core 604 and a winding 606 wound around a central longitudinal portion of such core is but one example configuration. Numerous other coil configurations could be provided. In the illustrated example, core 604 can be formed from a ferrite material, e.g., a ceramic or other non-metallic/non-conductive material with ferromagnetic particles disposed therein. Alternatively, in some embodiments, a metallic core made from magnet steel sheets like those used for transformer or motor cores could be used. Likewise, the wireless power transfer coil could be positioned in any desired orientation with respect to electronic device 600 and the window through housing 602. The illustrated horizontal configuration is but one exemplary configuration.

Electronic device 600 can include a non-metallic cover 608 that can be disposed within the window through housing 602. Non-metallic cover 608 can be formed from any suitable material. Suitability can include: (1) being non-conductive so as to allow for magnetic coupling between the wireless power transfer winding and a corresponding external wireless power transfer winding, (2) having mechanical properties that provide a suitable degree of mechanical protection (including moisture ingress protection) for the wireless power transfer winding and other internal components of electronic device 600, (3) a surface finish that provides an aesthetically-pleasing look to electronic device by matching or otherwise coordinating with housing 602, and (4) any other desired properties. Exemplary materials that may be used include polymer materials such as plastic, rubber, etc.

Non-metallic cover 608 can also incorporate or otherwise provide for one or more ferromagnetic regions 610 with suitable cosmetic coatings 672 on at least the exposed portions of ferromagnetic regions 610. Ferromagnetic regions 610 can improve the degree of magnetic coupling between the wireless power transfer coil and a complementary wireless power transfer coil in an external device. Ferromagnetic regions 610 can achieve this by serving as a relatively higher magnetic permeability path for flux lines induced by winding 606 in core 604 into a corresponding power transfer winding of an external device. Such an arrangement can also reduce the effective distance between the respective wireless power transfer coils, which can also improve magnetic coupling. To that end, ferromagnetic regions 610 may be dimensioned and positioned relative to core 604 so as to provide the desired flux path. As a result, the dimensions of ferromagnetic regions 610 may correspond to certain features of core 604 (e.g., the dumbbell ends) and may have a height that can serve to reduce or eliminate the airgap between core 604 and a corresponding core of a counterpart wireless power transfer coil in an external device. Exemplary ferromagnetic region materials and construction techniques are described in greater detail above, but in general may include a suitable non-metallic matrix or substrate material with a distribution of ferromagnetic particles disposed therein.

Cosmetic coating 672 may be selected as any material that provides a desirable aesthetic match to the exterior of device 600 (i.e., housing 602 and/or non-metallic cover 608) while minimizing interference with the desired magnetic properties discussed above. Such minimizing of interference can be accomplished by having a suitably thin material or by any other suitable technique. In some cases, cosmetic coating 672 may be, but need not be, the same material as non-metallic cover 608. Likewise, in some cases, such an arrangement could be formed by a process similar to that described above with respect to FIG. 3, in which the final product is something like the result of process step 334 (i.e., before the second co-finishing step 336) in which the ferromagnetic region material 310 is covered by the non-metallic cover material 308 on the exposed side (i.e., the bottom of the combined structure in FIG. 3 could be the external face of the combined structure including non-metallic cover 608, ferromagnetic region 610, and external coating 672 (which happens to be integral with the remainder of the non-metallic cover structure.

Non-metallic cover 608 can be secured in the window through housing 602 in a variety of ways, including an interference fit (in which friction between the mating surfaces of housing 602 and non-metallic cover 608 retain the non-metallic cover in position), adhesives (in which housing 602 is bonded to non-metallic cover 608), or mechanical retaining features (such as flanges or other fixtures that serve to retain non-metallic cover 608). In some embodiments, other securing techniques or combinations of the listed securing techniques could be used as appropriate. Likewise, ferromagnetic regions 610 may be retained in non-metallic cover 608 in corresponding fashion or may be formed substantially integral therewith. Alternatively and as described above, a flange on the internal side of non-metallic cover 608 and/or ferromagnetic regions 610 could prevent them from falling out of the window, while the wireless power transfer winding could be secured inside the housing of the electronic device by any appropriate technique, and the immobility of the wireless power transfer winding could prevent non-metallic cover 608 and/or cosmetic ferries 610 from falling out of the window into the inside of the housing.

FIG. 7 depicts an electronic device 700 with a housing 702, a window therethrough for wireless power transfer, and a non-metallic cover 708 incorporating ferromagnetic regions in the form of a ferrite 710 with a cosmetic coating 772 in which the coating covers both the ferrite 710 and the surrounding non-metallic cover 708. Housing 702 may be metallic or non-metallic. More specifically, FIG. 7 depicts a cross sectional view showing housing 702, which has a window or opening therethrough that is located “above” the wireless power transfer coil, which can include winding 706 wrapped around a magnetic core 704. Although illustrated and described herein as “above,” it is to be understood that the window through the housing and wireless power transfer coil could be disposed in any orientation in any surface of the electronic device, such that it could be above, below, beside, etc. Also, the illustrated orientation and configuration of the wireless power transfer coil, with a “dumbbell-shaped” core 704 and a winding 706 wound around a central longitudinal portion of such core is but one example configuration. Numerous other coil configurations could be provided. In the illustrated example, core 704 can be formed from a ferrite material, e.g., a ceramic or other non-metallic/non-conductive material with ferromagnetic particles disposed therein. Alternatively, in some embodiments, a metallic core made from magnet steel sheets like those used for transformer or motor cores could be used. Likewise, the wireless power transfer coil could be positioned in any desired orientation with respect to electronic device 700 and the window through housing 702. The illustrated horizontal configuration is but one exemplary configuration.

Electronic device 700 can include a non-metallic cover 708 that can be disposed within the window through housing 702. Non-metallic cover 708 can be formed from any suitable material. Suitability can include: (1) being non-conductive so as to allow for magnetic coupling between the wireless power transfer winding and a corresponding external wireless power transfer winding, (2) having mechanical properties that provide a suitable degree of mechanical protection (including moisture ingress protection) for the wireless power transfer winding and other internal components of electronic device 700, (3) a surface finish that provides an aesthetically-pleasing look to electronic device by matching or otherwise coordinating with housing 702, and (4) any other desired properties. Exemplary materials that may be used include polymer materials such as plastic, rubber, etc.

Non-metallic cover 708 can also incorporate or otherwise provide for one or more ferromagnetic regions 710 with a suitable cosmetic coating 772 covering the exposed portions of ferromagnetic regions 710 as well as non-metallic cover 708 to provide a more uniform surface finish. Ferromagnetic regions 710 can improve the degree of magnetic coupling between the wireless power transfer coil and a complementary wireless power transfer coil in an external device. Ferromagnetic regions 710 can achieve this by serving as a relatively higher magnetic permeability path for flux lines induced by winding 706 in core 704 into a corresponding power transfer winding of an external device. Such an arrangement can also reduce the effective distance between the respective wireless power transfer coils, which can also improve magnetic coupling. To that end, ferromagnetic regions 710 may be dimensioned positioned relative to core 704 so as to provide the desired flux path. As a result, the dimensions of ferromagnetic regions 710 may correspond to certain features of core 704 (e.g., the dumbbell ends) and may have a height that can serve to reduce or eliminate the airgap between core 704 and a corresponding core of a counterpart wireless power transfer coil in an external device. Exemplary ferromagnetic region materials and construction techniques are described in greater detail above, but in general may include a suitable non-metallic matrix or substrate material with a distribution of ferromagnetic particles disposed therein.

Cosmetic coating 772 may be selected as any material that provides a desirable aesthetic match to the exterior of device 700 (i.e., housing 702) while minimizing interference with the desired magnetic properties discussed above. Such minimizing of interference can be accomplished by having a suitably thin material or by any other suitable technique. Non-metallic cover 708 can be secured in the window through housing 702 in a variety of ways, including those described above with reference to FIG. 6.

The foregoing describes exemplary embodiments of ferromagnetic regions for use in devices with wireless power transfer features and housings. Such systems may be used in a variety of applications but may be particularly advantageous when used in conjunction with wireless power transfer systems electronic devices such as mobile phones, smart watches, and/or tablet computers including accessories for such devices such as wireless earphones, styluses, and the like. However, any system for which increased overall efficiency is desired may advantageously employ the techniques described herein. Although numerous specific features and various embodiments have been described, it is to be understood that, unless otherwise noted as being mutually exclusive, the various features and embodiments may be combined in various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. An electronic device comprising:
a housing having a window therethrough;
a wireless power transfer coil disposed inside the housing adjacent the window; and
a non-metallic cover disposed within the window that protects the wireless power transfer coil, the non-metallic cover incorporating at least one ferromagnetic region that improves magnetic coupling of the wireless power transfer coil to a corresponding wireless power transfer coil of another device by providing a high magnetic permeability flux path;
wherein the non-metallic cover and the at least one ferromagnetic region have surface finishes selected to visually match or coordinate with the housing.

2. The electronic device of claim 1 wherein the non-metallic cover is formed from a polymer material.

3. The electronic device of claim 1 wherein the non-metallic cover is plastic or rubber.

4. The electronic device of claim 1 wherein the at least one ferromagnetic region has one or more dimensions selected to match a corresponding dimension of a core of the wireless power transfer coil.

5. The electronic device of claim 4 wherein the at least one ferromagnetic region has a thickness selected to reduce or eliminate an air gap between the core of the wireless power transfer coil and a core of the corresponding wireless power transfer coil of another device.

6. The electronic device of claim 1 wherein the ferromagnetic region is formed from a non-metallic matrix or substrate material with ferromagnetic particles disposed therein.

7. The electronic device of claim 1 wherein the housing is metallic.

8. The electronic device of claim 6 wherein the non-metallic matrix or substrate material is the same material as the non-metallic cover.

9. The electronic device of claim 6 wherein the ferromagnetic particles are powdered causing the ferromagnetic region to have an isotropic magnetic flux characteristic.

10. The electronic device of claim 6 wherein the ferromagnetic particles are flakes and are oriented within the ferromagnetic region so as to cause the ferromagnetic region to have an anisotropic magnetic flux characteristic.

11. A method of forming a cover for a window through a housing of an electronic device, the cover incorporating a ferromagnetic region that improves magnetic coupling of a wireless power transfer coil in the electronic device to a corresponding wireless power transfer coil of another device by providing a high magnetic permeability flux path, the method comprising:
disposing material including a non-metallic matrix or substrate having ferromagnetic particles dispersed therein into a reservoir of a non-metallic blank;
co-finishing the resulting structure to provide desired dimensions and surface finish of the cover and ferromagnetic region.

12. The method of claim 11 further comprising curing the material disposed in the reservoir of the non-metallic blank prior to co-finishing the resulting structure.

13. The method of claim 11 wherein the non-metallic blank is a molded polymer part.

14. The method of claim 11 wherein the co-finishing step is a machining operation.

15. The method of claim 11 wherein the co-finishing step is applied to more than one face of the resulting structure.

16. An electronic device comprising:
a housing having a window therethrough;
a wireless power transfer coil disposed inside the housing adjacent the window; and
a non-metallic cover disposed within the window that protects the wireless power transfer coil, the non-metallic cover incorporating at least one ferromagnetic region that improves magnetic coupling of the wireless power transfer coil to a corresponding wireless power transfer coil of another device by providing a high magnetic permeability flux path;
wherein at least one of the non-metallic cover and ferromagnetic region are coated to provide a surface finish selected to visually match or coordinate with the housing.

17. The electronic device of claim 16 wherein both the non-metallic cover and the ferromagnetic region are coated to provide a surface finish selected to visually match or coordinate with the housing.

18. The electronic device of claim 16 wherein the coating material is the same material as the non-metallic cover.

19. The electronic device of claim 16 wherein the ferromagnetic region is formed from a non-metallic matrix or substrate material with ferromagnetic particles disposed therein.

20. The electronic device of claim 19 wherein the ferromagnetic particles are flakes oriented within the ferromagnetic region so as to cause the ferromagnetic region to have an anisotropic magnetic flux characteristic.
